(19) United States
(12) Patent Application Publication
(10) Pub. No.: US 2026/0112947 A1
(43) Pub. Date: Apr. 23, 2026

(54) FREE CURRENT AND ELECTRIC DISCHARGE MACHINING CURRENT MITIGATION SYSTEM FOR AN ELECTRIC DRIVE UNIT

(71) Applicant: GM Global Technology Operations LLC, Detroit, MI (US)

(72) Inventors: Zachary Strand, Salem, OR (US); Alireza Fatemi, Canton, MI (US); Jack M. Gayney, Grosse Ile, MI (US)

(21) Appl. No.: 18/923,121

(22) Filed: Oct. 22, 2024

(51) Int. Cl. H02K 11/40; H02K 5/173; H02K 7/08

(52) U.S. Cl. CPC H02K 11/40; H02K 5/1732; H02K 7/083

(57) ABSTRACT

A system and method of mitigating free and electric discharge machining (EDM) currents in an electric drive unit. The electric drive unit includes an electric motor having a rotor and a rotor shaft having a first shaft portion extending from the first side of the rotor and a second shaft portion extending from the second side of the rotor. The first shaft portion includes a first number of current paths and the second shaft portion includes a second number of current paths greater than the first number of current paths. The first shaft portion includes an electrically insulating bearing and the second shaft portion includes an electrically conductive device, therefore the first shaft portion includes a first impedance and the second shaft portion includes second impedance less than the first impedance.

### INTRODUCTION

The present disclosure relates to electric drive units having electric motors, more particularly to a system for mitigating free and electric discharge machining (EDM) currents in an electric drive unit.

Modern battery electric vehicles, including full electric vehicles and hybrid electric vehicles, have electric drive units configured to convert electrical energy from a generator or a battery pack to mechanical energy to power the wheels of the vehicles. A typical electric drive unit includes a power electronic unit, one or more electric motors, and a gear box such as a transmission unit. The electric motor is a main component of the electric drive unit, as the electric motor is responsible for generating the torque needed to propel the vehicle. The power electronic unit is responsible for controlling the flow of electrical energy to the electric motor, while the transmission is responsible for adjusting the torque and speed of the electric motor.

An electric motor includes a stator defining a hollow core and a rotor disposed in the hollow core. The rotor includes a rotor shaft supported by bearings. An electric current is conveyed through windings in the stator to generate a moving magnetic field that interacts with the rotor disposed within the stator to generate a torque that turns the rotor including the rotor shaft. The rotor typically uses permanent magnets to produce a constant magnetic field (CMF) that interacts with a rotating magnetic field (RMF) generated by a three-phase alternating current (AC) supplied to a field coil of the stator. The speed of the rotor may be varied by controlling the frequency of the 3-phase current. Alternative to using permanent magnets, the rotor may use coil windings that function as magnets when excited by a direct current (DC). The opposite poles of the CMF and RMF attract and lock upon each other thereby causing the rotor to rotate at the same rate of rotation as that of the RMF.

Circulating currents and capacitive electric discharge machining (EDM) currents are known to be present in electric motors, especially those of variable speed electric motors. Circulating currents are flowing electrical currents that occur in electric motors as a result of magnetic asymmetry between the stator and rotor. EDM currents are generated when a voltage drop across a rotor shaft bearing exceeds a certain threshold. Over time, circulating and EDM currents may cause premature wear, including wear on the bearings of the electric motor.

Thus, while current electric drive units having electric motors achieve their intended purpose, there is a need for a system to mitigate free and EDM currents in order to minimize premature wear in electric motors.

### SUMMARY

According to several aspects, a system for of mitigating free and electric discharge machining (EDM) currents in an electric drive unit is provided. The system includes an electric motor having a rotor with a first side and a second side opposite the first side, and a rotor shaft extending through the rotor along an axis of rotation. The rotor shaft includes a first shaft portion extending from the first side of the rotor and a second shaft portion extending from the second side of the rotor. The first shaft portion includes a first number of electrical current paths and the second shaft portion includes a second number of electrical current paths greater than the first number of electrical current paths. The first shaft portion includes a first impedance and the second shaft portion includes second impedance less than the first impedance.

In an additional aspect of the present disclosure, the system further includes a first bearing supporting the first shaft portion and a second bearing supporting the second shaft portion. The first bearing is an electrically insulated bearing. The second bearing is an electrically conductive bearing.

In another aspect of the present disclosure, the electric motor further includes a housing, and an electrically conductive device in electrical contact with the second shaft portion and the housing. The electrically conductive device is disposed between the rotor and a current path immediately adjacent to the rotor.

In another aspect of the present disclosure, the electric motor further includes a housing, an electrically insulated first shaft portion, and an electrically conductive second shaft portion in electrical communication with the housing.

In another aspect of the present disclosure, the system further includes an output shaft coupled to the second shaft portion. The output shaft is supported by at least one electrically conductive bearings.

In another aspect of the present disclosure, the system further includes an output shaft co-axially disposed within an inner diameter of the rotor shaft.

In another aspect of the present disclosure, each of the first number of current paths of the first shaft portion is electrically insulated.

In another aspect of the present disclosure, the electrically insulated bearing is a rolling-element bearing having an electrically insulated ceramic roller disposed between an inner race and an outer race.

According to several aspects, a method of mitigating free and electric discharge machining (EDM) currents in an electric drive unit is provided. The method includes determining electrically conductive paths on a rotor shaft extending through a rotor of an electric motor; determining a number of electrically conductive paths on each side of the rotor on the rotor shaft; identifying a side of the rotor having a greater number of electrically conductive paths with respect to another side of the rotor having a lesser number of electrically conductive paths; insulating all electrically conductive paths on the side of the rotor having the lesser number of electrically conductive paths; and providing an electrically conductive device on the side of the rotor having the greater number of available electric paths.

In an additional aspect of the present disclosure, the method further includes determining electrically conductive paths through bearings and gears.

In another aspect of the present disclosure, the method further includes providing an insulating bearing.

In another aspect of the present disclosure, the method further includes providing the electrically conductive device between the rotor and a current path nearest to the rotor. The electrically conductive device is a carbon brush.

According to several aspects, an electric drive unit for an electric vehicle is provided. The electric drive unit includes an electric drive unit housing and an electric motor disposed in the electric drive unit housing. The electric motor includes a rotor having a first side and a second side opposite the first side and a rotor shaft extending through the rotor along an axis of rotation. The rotor shaft includes a first shaft portion extending from the first side of the rotor and a second shaft portion extending from the second side of the rotor, an insulating element electrically insulating the first shaft portion, and an electrically conductive device in electrical communication with the second shaft portion.

In an additional aspect of the present disclosure, the first shaft portion includes a first plurality of electrically conductive paths. The second shaft portion includes a second plurality of electrically conductive paths. The second plurality of electrically conductive paths is greater than the first plurality of electrically conductive paths.

In another aspect of the present disclosure, the electric motor further includes an electrically insulated bearing supporting the first shaft portion to the housing, and an electrically conductive bearing supporting the second shaft portion to the housing.

In another aspect of the present disclosure, the electrically conductive device is a carbon brush. The carbon brush is in electrical contact with the second shaft portion between the second side of the rotor and an electrically conductive path immediately adjacent to the second side of the rotor.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic illustration of a plan view of an electric vehicle having an electric drive unit (EDU), according to an exemplary embodiment;

FIG. 2 is a partial cross-sectional view of a portion of an EDU containing an electric motor, according to an exemplary embodiment;

FIG. 3 is a block diagram of a method for mitigating both circulating and capacitive electric discharge machining (EDM) currents for a EDU having an electric motor, according to an exemplary embodiment;

FIG. 4 is a partial cross-sectional view of a portion of an EDU having a system for mitigating both circulating and capacitive EDM, according to an exemplary embodiment;

FIG. 5 is a partial cross-sectional view of a portion of an EDU having a system for mitigating both circulating and capacitive EDM, according to another exemplary embodiment; and

FIG. 6 is a partial cross-sectional view of a portion of an EDU having a system for mitigating both circulating and capacitive EDM, according to yet an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

When a component or element is referred to as being “on,” “engaged to,” “connected to,” or “coupled to” another component or element, it may be directly on, engaged, connected, or coupled to the other component or element, or intervening component or element may be present. In contrast, when a component or element is referred to as being “directly on,” “directly engaged to,” “directly connected to,” or “directly coupled to” another component or element, there may be no intervening component or element present.

Although the terms first, second, third, etc. may be used herein to describe various elements, components, portions, and/or sections, these elements, components, portions, and/or sections should not be limited by these terms, unless otherwise indicated. These terms are used to distinguish one elements, components, portions, and/or sections from another elements, components, portions, and/or sections.

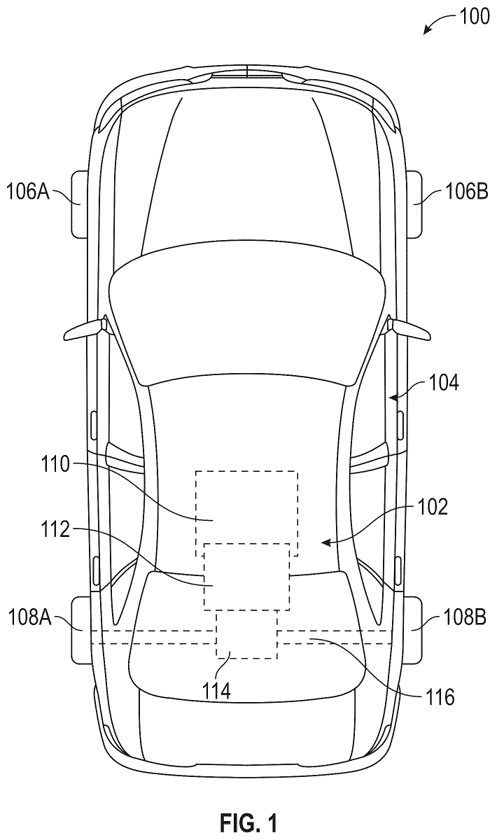

FIG. 1 is a diagrammatic illustration of a non-limiting example of electric vehicle 100 having an Electric Drive Unit (EDU) 102. The vehicle 100 generally includes a body 104 having front wheels 106A, 106B and rear wheels 108A, 108B. The front wheels 106A, 106B and the rear wheels 108A, 108B are each rotationally located near a respective corner of the body 104. The EDU 102 includes three (3) modules: a power electronic unit 110, an electric motor 112, and a gear box 114. While the vehicle 100 is depicted as a passenger car, other examples of the vehicle 100 include, but are not limited to, land vehicles such as motorcycles, trucks, sport utility vehicles (SUVs), and recreational vehicles (RVs), and non-land vehicles including marine vessels and aircrafts.

The power electronic unit 110, such as an inverter 110, are responsible for the conversion of DC voltage from rechargeable batteries (not shown) into a three-phase AC voltage for the overall operation and control of the electric motor 112. The electric motor 112 converts electrical energy into mechanical torque, which is transmitted through the gear box 114, such as a transmission 114, and mechanical linkages 116 to one or more of the wheels 106A, 106B, 108A, 108B for propelling the vehicle 100.

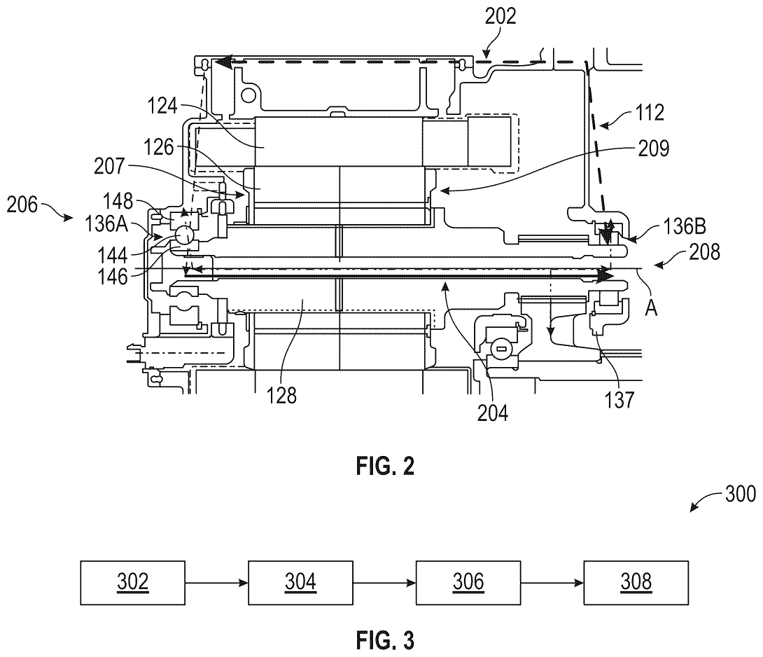

FIG. 2 is an illustration of a cross-sectional view of a portion of the EDU 102 containing the electric motor 112. The electric motor 112 includes a stator 124, a rotor 126 rotatable with respect to the stator 124, a rotor shaft 128 splined to the rotor 126. The rotor shaft 128 is formed of an electrically conductive metal such as steel and is rotatably supported about a rotational axis-A by a first bearing 136A and a second bearing 136B. In a non-limiting example, the first bearing 136A and the second bearing 136B may be rolling-element bearings supported by a structural component of the EDU 102 such as a housing 137 of the electric motor 112. An exemplary rolling-element bearing 136A, 136B may include rolling elements 144 disposed between two concentric grooved rings 146, 148, also referred to as an inner-race 146 and an outer-race 148. The outer-race 148 is located radially further from the rotational axis-A, than the inner-race 146.

In operation, an electric current is conveyed through windings in the stator 124 to generate a moving magnetic field that interacts with the rotor 126 disposed within the stator 124 to generate a torque that turns the rotor 126 and rotor shaft 128. The rotational speed of the rotor 126 may be varied by controlling the frequency of a 3-phase current to generates a torque output through the rotor shaft 128. Referring back to FIG. 1, the torque output from the rotor shaft 128 is conveyed to the gear box 114, which then selectively distributes the torque to one or more of the vehicle wheels 106A-B, 108A-B to propel the vehicle 100.

Referring back to FIG. 2, due to variations in built and balance of the rotor 126 with respect to the stator 124, a circulating current flow may be induced through the rotor shaft 128 and portions of the EDU 102. An exemplary path of the circulating current thorough the EDU 102 is shown as a dashed line 202. The circulating current follows a path of the least impedance to complete a circuit across the rotor shaft 128 and through a conductive portion of the housing 137 of the electric motor 112. The first bearing 136A and the second bearing 136B function as electrical conductors for the circulating current flowing from the rotor shaft 128 to the housing 137 and returning to the rotor shaft 128. A capacitive EDM current is also generated when a voltage difference between the rotor shaft 128 and the housing 137 exceeds a certain current density threshold. The current density threshold is the breakdown voltage of the insulating media that is separating the bearing rolling elements from the housing. An exemplary path of the EDM current is shown as a solid line 204. Over time, the circulating and EDM currents may cause premature erosion on the bearings 136A, 136B of the electric motor 112 and other electrically conductive portions of the EDM, such as the gear box 114. Furthermore, capacitive EDM currents follow the lowest impedance (Z) path to ground which is dependent on operating conditions of the bearings and gears, thereby possibly eroding the bearings and gears in the path of the EDM currents.

FIG. 3 shows a block diagram of a method for mitigating both circulating and capacitive EDM currents for a EDU 102 having an electric motor 112 (Method 300). At Block 302, all electrical paths, also referred to as current paths, through mechanical components on the rotor shaft 128, including bearings and gears are identified. Usually the side of the rotor shaft 128 that is connected to a load has a higher number of current paths. At Block 304, the number of current paths on each side of the rotor 126 of the electric motor 112 on the rotor shaft 128 are determined. At Block 306, all current paths on the side of the rotor 126 with less available current paths are insulated and/or configured to ensure sufficient impedance to reduce circulating currents below the current density threshold for damage. This step will ensure that the circulating current is reduced by creating a high impedance path on one side of the rotor shaft 128 having the less available current paths. At Block 308, a conductive device 129, such as a carbon brush, is provided on the side of the rotor shaft 128 having the greater number of available electric paths, preferably between the rotor shaft 128 and the current path nearest to the rotor shaft 128. The conductive device 129, such as the carbon brush, protects by providing a low impedance path for circulating currents on that end of the shaft around the uninsulated components. The conductive device 129 increases the magnitude which is mitigated by the insulated bearing in the path.

Based on the Method 300, in a non-limiting example referring to FIG. 2, a first end portion 206 of the rotor shaft 128 extending from a first side 207 of the rotor shaft 128 is determined to have a lower number of current paths as compared to a second end portion 208 of the rotor shaft 128 extending from a second side 209 of the rotor shaft 128. Therefore, the first bearing 136A located on the first end portion 206 is configured to be an electrically insulated bearing. A non-limiting example of an insulated bearing is a rolling bearing having an inner race, an outer race, and a plurality of electrically insulated rolling elements therebetween. The rolling elements may comprise of an electrically insulating material such as ceramic. The second bearing 136B located on the second end portion 208 may be a standard metallic bearing such as a steel bearing or configured to provide a low impedance for the discharge of circulating and EDM currents. A low impedance conductive device 129 such as a carbon brush may be electrically coupled to the second end.

In short, the side of the rotor shaft 128 having a lesser number of current paths is provided with a higher impedance path than the other side of the rotor shaft 128 having a greater number of current paths. In other words, the current paths are electrically insulated on the side of the rotor shaft 128 having a lesser number of current paths. An electrically conductive device 129 is provided on the side of the rotor shaft 128 having a greater number of current paths. The electrically conductive device 129 may be electrically grounded to the motor housing. Alternatives to carbon brushes are graphite stick brushes or bearings with conductive grease.

System 400 provides a first impedance path on the rotor shaft 128 portion on the side of the rotor shaft 128 having a lesser number of current paths and a second impedance on the rotor shaft 128 portion on the side of the rotor shaft 128 having a greater number of current paths. The first impedance is higher than the second impedance. The first current path is also referred to as a high impedance path and the second current path is also referred to as a low impedance path. The rotor shaft portion 206 on the side of the rotor 126 having a lesser number of current paths may be electrically insulated to provide a higher impedance than the rotor shaft portion 208 on the side of the rotor shaft 128 having a greater number of current paths. The rotor shaft portion 208 on the side of the rotor shaft 128 having a greater number of current paths is provided with an electrically conductive device 129 to decrease the impedance of the circuit. The electrically conductive device 129 provides a low impedance path.

The low impedance path allows for constant capacitive EDM current discharge and circulating current discharge resulting in reduced electrical erosion damage to the bearings and gears on second end of the shaft. The insulated end of the rotor shaft 128 mitigates the circulating current for all motor axis bearings by increasing the path impedance.

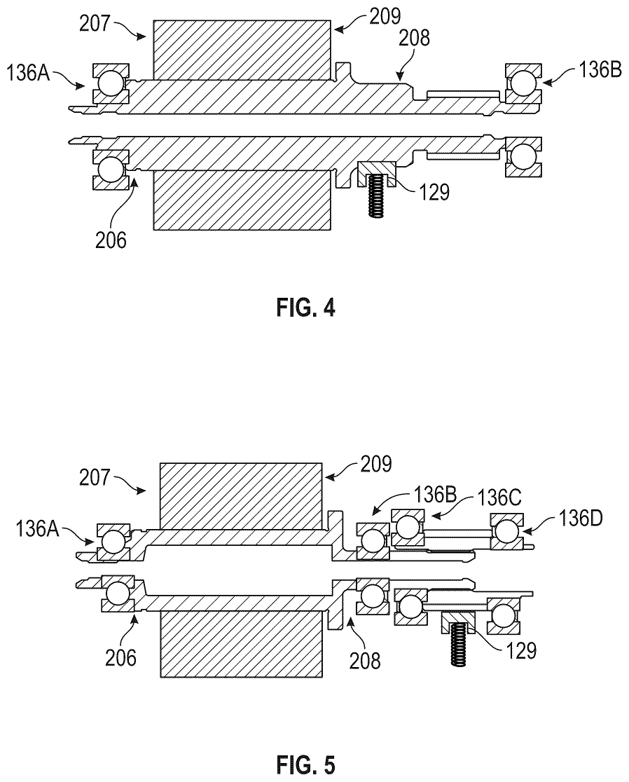

FIGS. 4 through 6 are partial cross-sections of alternative embodiments of electric motors having a system for mitigating free and electric discharge machining (EDM) currents (System 400). The System 400 provides protection from free current damage on the gears and bearings within an EDU by strategically placing high and low impedance paths in specific locations of the electric motor 112. The high impedance paths are placed on one end portion of the rotor shaft 128 having a lower number of current paths and the low impedance paths are placed on the other end portion of the rotor shaft 128 having a higher number of current paths.

Referring to FIG. 4, the electric motor 112 includes a rotor shaft 128 splined to a rotor 126. The rotor shaft 128 includes a first end portion 206 and a second end portion 208 opposite the first end portion 206. The first end portion 206 includes a lesser number of current paths with respect to the second end portion 208. The rotor shaft 128 is rotatably supported about a rotational axis-A by a first bearing 136A located on the first end portion 206 and a second bearing 136B located on the second end portion 208. In a non-limiting example, the first bearing 136A and the second bearing 136B are rolling-element bearing mounted to a structural component (not shown) of the EDU 102. The first bearing 136A is configured to be a high impedance bearing thereby increasing the impedance of the first end portion 206. The second bearing 136B is configured to be a low impedance bearing thereby decreasing the impedance of the second end portion 208. An electrically conductive device 129, also known as a low impedance conductive device 129, may be provided to the second end portion 208. The purpose of the conductive device 129 is to allow a low impedance path for EDM and circulating currents. The conductive device 129 increases the magnitude of the circulating currents.

Referring to FIG. 5, the electric motor 112 includes a rotor shaft 128 splined to a rotor 126. The rotor shaft 128 includes a first end portion 206 and a second end portion 208 opposite the first end portion 206. The second end portion 208 is splined to an output shaft. The first end portion 206 includes a lesser number of current paths with respect to the second end portion 208. The rotor shaft 128 is rotatably supported about a rotational axis-A by a first bearing 136A located on the first end portion 206 and a second bearing 136B located on the second end portion 208. The output shaft is rotatably supported about the rotational axis-A by a third bearing 136C and a fourth bearing 136D.

In a non-limiting example, the first bearing 136A, the second bearing 136B, the third bearing 136C, and the fourth bearing 136D are rolling-element bearing mounted to a structural component (not shown) of the EDU 102. The first bearing 136A is configured to be a high impedance bearing thereby increasing the impedance of the first end portion 206. The second bearing 136B, third bearing 136C, and fourth bearing 136D are configured to be a low impedance bearing thereby decreasing the impedance of the second end portion 208. An electrically conductive device 129, also known as a low impedance conductive device 129, may be provided to the second end portion 208.

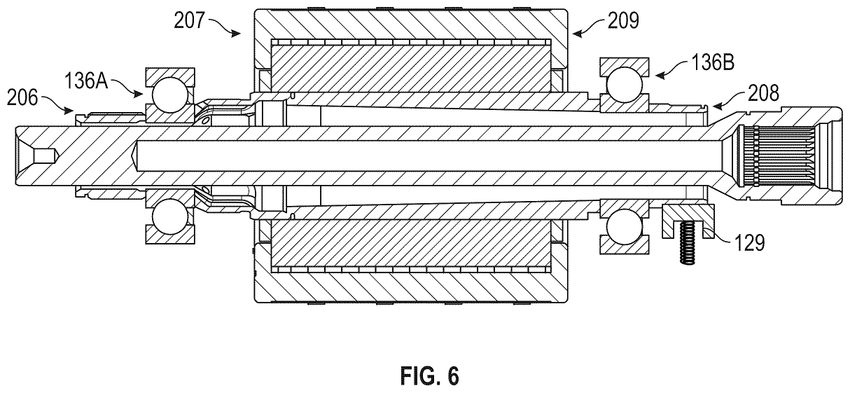

Referring to FIG. 6, the electric motor 112 includes a rotor shaft 128 splined to a rotor 126. The rotor shaft 128 includes a first end portion 206 and a second end portion 208 opposite the first end portion 206. The first end portion 206 includes a lesser number of current paths with respect to the second end portion 208. The rotor shaft 128 is rotatably supported about a rotational axis-A by a first bearing 136A located on the first end portion 206 and a second bearing 136B located on the second end portion 208. An output shaft is co-axially disposed within the rotor shaft 128. In a non-limiting example, the first bearing 136A and the second bearing 136B are rolling-element bearing mounted to a structural component (not shown) of the EDU 102. The first bearing 136A is configured to be a high impedance bearing thereby increasing the impedance of the first end portion 206. The second bearing 136B is configured to be a low impedance bearing, such as a standard metallic bearing, thereby decreasing the impedance of the second end portion 208. Insulated bearings can be fully ceramic, or hybrid bearing with ceramic rollers, or use of an insulated layer in the bearing environment, such as an insulated ring or gasket that could be part of the bearing assembly itself or could be a separate insert in between bearing and the rest of the housing. An electrically conductive device 129, also known as a low impedance conductive device 129, may be provided to the second end portion 208.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A system for of mitigating free and electric discharge machining (EDM) currents in an electric drive unit, comprising:
an electric motor comprising:
a rotor having a first side and a second side opposite the first side; and
a rotor shaft extending through the rotor along an axis of rotation, wherein the rotor shaft includes a first shaft portion extending from the first side of the rotor and a second shaft portion extending from the second side of the rotor;
wherein the first shaft portion includes a first number of current paths and the second shaft portion includes a second number of current paths greater than the first number of current paths; and
wherein the first shaft portion includes a first impedance and the second shaft portion includes second impedance less than the first impedance.

2. The system of claim 1, further comprising:
a first bearing supporting the first shaft portion and a second bearing supporting the second shaft portion; and
wherein the first bearing is an electrically insulated bearing.

3. The system of claim 2, wherein the second bearing is an electrically conductive bearing.

4. The system of claim 2, wherein the electric motor further comprises a housing, and an electrically conductive device in electrical contact with the second shaft portion and the housing.

5. The system of claim 4, wherein the electrically conductive device is disposed between the rotor and a current path immediately adjacent to the rotor.

6. The system of claim 1, wherein the electric motor further comprises a housing, an electrically insulated first shaft portion, and an electrically conductive second shaft portion in electrical communication with the housing.

7. The system of claim 1, further comprises:
an output shaft coupled to the second shaft portion; and
wherein the output shaft is supported by at least one electrically conductive bearings.

8. The system of claim 1, further comprising an output shaft co-axially disposed within an inner diameter of the rotor shaft.

9. The system of claim 1, wherein each of the first number of current paths of the first shaft portion is electrically insulated.

10. The system of claim 2, wherein the electrically insulated bearing is a rolling-element bearing having an electrically insulated ceramic roller disposed between an inner race and an outer race.

11. A method of mitigating free and electric discharge machining (EDM) currents in an electric drive unit, comprising:
determining electrically conductive paths on a rotor shaft extending through a rotor of an electric motor;
determining a number of electrically conductive paths on each side of the rotor on the rotor shaft;
identifying a side of the rotor having a greater number of electrically conductive paths with respect to another side of the rotor having a lesser number of electrically conductive paths;
insulating all electrically conductive paths on the side of the rotor having a lesser number of electrically conductive paths; and
providing an electrically conductive device on the side of the rotor having the greater number of available electric paths.

12. The method of claim 11, wherein determining electrically conductive paths on a rotor shaft extending through a rotor of an electric motor includes electrically conductive paths through bearings and gears.

13. The method of claim 11, further comprising providing an electrically insulated bearing on the side of the rotor having the lesser number of electrically conductive paths.

14. The method of claim 11, wherein providing an electrically conductive device on the side of the rotor having the greater number of available electric paths includes providing the electrically conductive device between the rotor and a current path nearest to the rotor.

15. The method of claim 14, wherein the electrically conductive device is a carbon brush.

16. An electric drive unit for an electric vehicle, comprising:
an electric drive unit housing;
an electric motor disposed in the electric drive unit housing, wherein the electric motor includes:
a rotor having a first side and a second side opposite the first side;
a rotor shaft extending through the rotor along an axis of rotation, wherein the rotor shaft includes a first shaft portion extending from the first side of the rotor and a second shaft portion extending from the second side of the rotor;
an insulating element electrically insulating the first shaft portion; and
an electrically conductive device in electrical communication with the second shaft portion.

17. The electric drive unit for an electric vehicle of claim 16,
wherein the first shaft portion includes a first plurality of electrically conductive paths;
wherein the second shaft portion includes a second plurality of electrically conductive paths; and
wherein the second plurality of electrically conductive paths is greater than the first plurality of electrically conductive paths.

18. The electric drive unit for an electric vehicle of claim 17, wherein the electric motor further includes:
an electrically insulated bearing supporting the first shaft portion to the housing; and
an electrically conductive bearing supporting the second shaft portion to the housing.

19. The electric drive unit for an electric vehicle of claim 18, wherein the electrically conductive device is a carbon brush.

20. The electric drive unit for an electric vehicle of claim 19, wherein the carbon brush is in electrical contact with the second shaft portion between the second side of the rotor and an electrically conductive path immediately adjacent to the second side of the rotor.
